(19) United States
(12) Patent Application Publication
(10) Pub. No.: US 2012/0188224 A1
(43) Pub. Date: Jul. 26, 2012

(54) DATA PROCESSING METHOD, DATA DRIVING CIRCUIT PERFORMING THE SAME AND DISPLAY APPARATUS HAVING THE DATA DRIVING CIRCUIT

(75) Inventors: Sang-Gon LEE, Daejeon (KR); Ock-Jin KIM, Asan-si (KR); Yong-Soon LEE, Cheonan-si (KR); Chang-Sin KIM, Asan-si (KR)

(73) Assignee: SAMSUNG ELECTRONICS CO., LTD., Suwon-si (KR)

(21) Appl. No.: 13/278,683

(22) Filed: Oct. 21, 2011

(30) Foreign Application Priority Data
Jan. 21, 2011 (KR) 2011-0006481

(51) Int. Cl. G06F 3/038

(52) U.S. Cl. 345/214

(57) ABSTRACT

A data processing method for a display apparatus includes comparing data signals outputted to a first data line and a second data line of a plurality of data lines of a data driving circuit in the display apparatus to generate an output buffer control signal, and outputting output signals from at least one amplifier of a plurality of amplifiers of an output buffer in the data driving circuit to the first data line and the second data line, where the at least one amplifier is selected based on the output buffer control signal.

This application claims priority to Korean Patent Application No. 2011-0006481, filed on Jan. 21, 2011, and all the benefits accruing therefrom under 35 U.S.C. §119, the content of which in its entirety is herein incorporated by reference.

### BACKGROUND OF THE INVENTION

(1) Field of the Invention

Exemplary embodiments of the present invention relate to a data processing method, a data driving circuit for performing the data processing method and a display apparatus having the data driving circuit. More particularly, exemplary embodiments of the present invention relate to a data processing method with reduced power consumption, a data driving circuit for performing the data processing method and a display apparatus having the data driving circuit.

(2) Description of the Related Art

Recently, a liquid crystal display (“LCD”) apparatus driven with low power consumption has been developed. In a driving integrated circuit (“IC”), a current consumption of a source driving IC in a small-sized or medium-sized panel is typically greater than a current consumption of a source driving IC in a large-sized panel. Thus, a method to reduce the current consumption of the driving IC is required, and a logic circuit and an analogue of the driving IC decreasing the current consumption have been developed.

In addition, a technology adopting a low power pixel array (“LPPA”) structure has been developed. In a LPPA structure, a column inversion method is applied to reduce power consumption.

However, the number of gate lines in the LPPA structure is greater than twice the number of gate lines in a conventional pixel array structure, such that charging time of a pixel is about a half the charging time of the conventional pixel array structure. Thus, a charging margin is insufficient, and a charging rate decreases.

Accordingly, a driving IC with increased slew rate is developed to increase the charging rate. However, when the slew rate increases, a bias current of an amplifier of the driving IC increases to the maximum, and the current consumption of the driving IC thereby increases.

### BRIEF SUMMARY OF THE INVENTION

Exemplary embodiments of the present invention provide a data processing method capable of decreasing a current consumption without decreasing a slew rate.

Exemplary embodiments of the present invention also provide a data driving circuit performing the data processing method.

Exemplary embodiments of the present invention also provide a display apparatus having the data driving circuit.

According to an exemplary embodiment of the present invention, a data processing method for a display apparatus includes comparing data signals outputted to a first data line and a second data line of a plurality of data lines of a data driving circuit in the display apparatus to generate an output buffer control signal, and outputting output signals from at least one amplifier of a plurality of amplifiers of an output buffer in the data driving circuit to the first data line and the second data line, where the at least one amplifier is selected based on the output buffer control signal.

In an exemplary embodiment, the outputting the output signals from the at least one amplifier to the first data line and the second data line may include connecting the first data line and the second data line to a same amplifier of the plurality of amplifiers, when the data signals outputted to the first data line and the second data line are substantially identical to each other, and respectively connecting the first data line and the second data line to different amplifiers of the plurality of amplifiers, when the data signals outputted to the first data line and the second data line are different from each other.

In an exemplary embodiment, the outputting the output signals from the at least one amplifier to the first data line and the second data line may include controlling turning-on and turning-off of a first switching element and a second switching element of the output buffer, where the plurality of amplifiers of the output buffer comprises a first amplifier corresponding to the first data line and a second amplifier corresponding to the second data line, where the first switching element respectively connects an input terminal of the first data line with an output terminal of the first amplifier and an input terminal of the second data line with an output terminal of the second amplifier, and where the second switching element connects the input terminal of the first data line and the input terminal of the second data line with each other.

In an exemplary embodiment, the outputting the output signals from the at least one amplifier to the first data line and the second data line may include: turning on the first switching element connected between the first amplifier and the first data line, turning off the first switching element connected between the second amplifier and the second data line, and turning-on the second switching element connected between the first data line and the second data line, when the data signals outputted to the first data line and the second data line are substantially identical to each other; and turning on the first switching element connected between the first amplifier and the first data line, turning on the first switching element connected between the second amplifier and the second data line, and turning off the second switching element, when the data signals outputted to the first data line and the second data line are different from each other.

In an exemplary embodiment, the first data line may be a k-th data line of the plurality of data lines, the second data line may be a (k+1)-th data line of the plurality of data lines, and the second switching element may connect the input terminals of the k-th and (k+1)-th data lines with each other, where k is a natural number.

In an exemplary embodiment, the first data line may be a k-th data line of the plurality of data lines, the second data line may be a (k+2)-th data line of the plurality of data lines, and the second switching element may connect the input terminals of the k-th and (k+2)-th data lines with each other, where k is a natural number.

In an exemplary embodiment, the comparing the data signals outputted to the first data line and the second data line may include generating a compensated data signal of an N-th frame using a preset data signal of an (N−1)-th frame and a data signal of the N-th frame received from an external device.

According to another exemplary embodiment of the present invention, a data driving circuit includes a data signal receiver, a digital-to-analogue converter which converts a signal received from the data signal receiver to an analogue data signal and an output buffer including: a plurality of amplifiers connected to a plurality of data lines, where the plurality of amplifiers includes a first amplifier corresponding to a first data line of the plurality of data lines and a second amplifier corresponding to a second data line of the plurality of data lines; a first switching element which respectively connects an input terminal of the first data line with an output terminal of the first amplifier and an input terminal of the second data line with an output terminal of the second amplifier; and a second switching element which connects the input terminal of the first data line and the input terminal of the second data line with each other.

In an exemplary embodiment, the data driving circuit may include a signal generator connected to the output buffer, where the signal generator generates an output buffer control signal and outputs the output buffer control signal to the output buffer.

According to still another exemplary embodiment of the present invention, a display apparatus includes a display panel including a plurality of data lines, a timing controller which outputs data signals, an output buffer controller which compares the data signals outputted to a first data line of the plurality of data lines and a second data line of the plurality of data lines to generate an output buffer control signal and a data driving circuit including an output buffer, where the data driving circuit includes an output buffer including: a plurality of amplifiers connected to the plurality of data lines of the display panel, where the plurality of amplifiers includes a first amplifier corresponding to the first data line and a second amplifier corresponding to the second data line; a first switching element which respectively connects an input terminal of the first data line with an output terminal of the first amplifier and an input terminal of the second data line with an output terminal of the second amplifier; and a second switching element which connects the input terminals of the first data line and the input terminal of the second data line with each other.

In an exemplary embodiment, the timing controller may output the data signal including the output buffer control signal to the data driving circuit.

In an exemplary embodiment, the output buffer controller may be connected to the timing controller and may output the output buffer control signal to the timing controller, and the timing controller may generate the data signals including the output buffer control signal.

In an exemplary embodiment, the data driving circuit may include a signal generator connected to the timing controller and the output buffer.

In an exemplary embodiment, the output buffer controller may be directly connected to the output buffer, and output the output buffer control signal to the output buffer.

In an exemplary embodiment, the display apparatus may include a data compensator connected to the output buffer controller and the timing controller, where the data compensator generates a compensated data signal of an N-th frame using a preset data signal of an (N−1)-th frame and a data signal of the N-th frame received from an external device.

In an exemplary embodiment, the output buffer controller may receive the compensated data signal of the N-th frame from the data compensator.

According to exemplary embodiments, when adjacent data lines output data signals substantially identical to each other, one amplifier which outputs the data signals is driven, and amplifiers other than the one amplifier are not driven.

In exemplary embodiments, the voltage of the amplifier is maintained by comparing the data signals of an N-th frame to an (N−1)-th frame, such that reduced number of amplifiers are driven.

Thus, power consumption of the data driving circuit and the display apparatus is substantially reduced.

### BRIEF DESCRIPTION OF THE DRAWINGS

The above and other features and advantages of the invention will become more apparent by describing in detailed exemplary embodiments thereof with reference to the accompanying drawings, in which:

FIG. 1 is a block diagram illustrating an exemplary embodiment of a display apparatus according to the present invention;

FIG. 2 is a block diagram illustrating an exemplary embodiment of an output buffer controller in FIG. 1;

FIG. 3 is a signal timing diagram of data signals inputted to an exemplary embodiment of a data driving circuit in FIG. 1;

FIG. 4 is a block diagram illustrating an exemplary embodiment of the data driving circuit in FIG. 1;

FIG. 5 is a schematic circuit diagram illustrating an exemplary embodiment of an output buffer of FIG. 4;

FIG. 6A is a schematic circuit diagram illustrating a connection of an exemplary embodiment of the output buffer of FIG. 5 when data lines output data signals substantially identical to each other;

FIG. 6B is a schematic circuit diagram illustrating a connection of the output buffer of FIG. 5 when the data lines output data signals different from each other;

FIG. 7 is a flow chart showing an exemplary embodiment of a method for driving the display apparatus of FIG. 1;

FIG. 8 is a schematic circuit diagram illustrating an alternative exemplary embodiment of the output buffer according the present invention;

FIG. 9 is a block diagram illustrating an alternative exemplary embodiment of the display apparatus according to of the present invention;

FIG. 10 is a block diagram illustrating an exemplary embodiment of a data driving circuit in FIG. 9; and

FIG. 11 is a flow chart showing an exemplary embodiment of a method for driving the display apparatus of FIG. 9.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, “connected” includes physically and/or electrically connected. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “under” relative to other elements or features would then be oriented “upper” or “above” relative to the other elements or features. Thus, the exemplary term “under” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the present invention will be explained in detail with reference to the accompanying drawings.

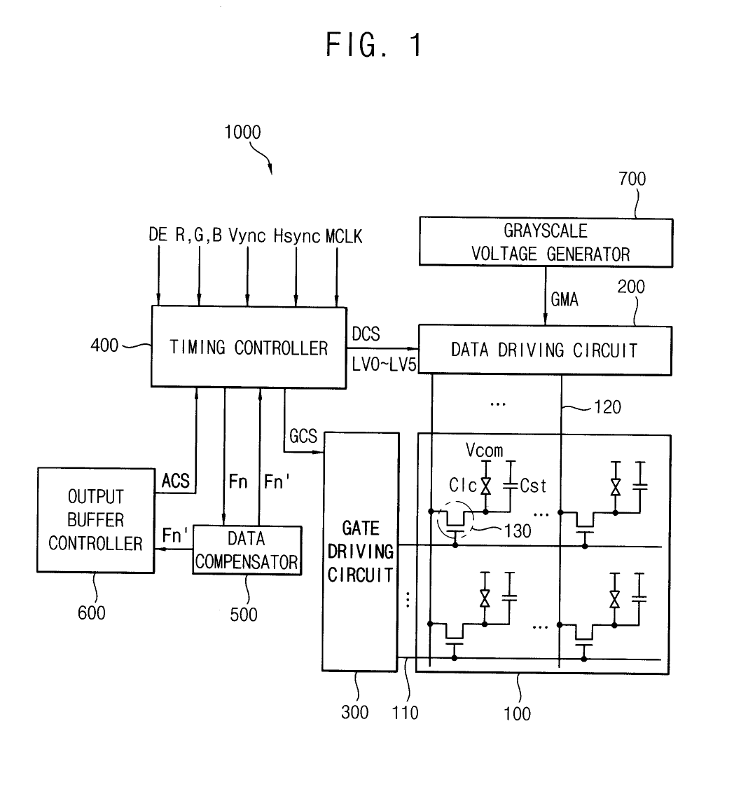

FIG. 1 is a block diagram illustrating an exemplary embodiment of a display apparatus according to the present invention;

Referring to FIG. 1, an exemplary embodiment of the display apparatus 1000 includes a display panel 100, a data driving circuit 200, a gate driving circuit 300, a timing controller 400, a data compensator 500, an output buffer controller 600 and a grayscale voltage generator 700.

The display panel 100 includes a display area in which a plurality of pixels P is disposed. A plurality of gate lines 110 extending along a first direction D1 and a plurality of data lines 120 extending along a second direction D2 crossing the first direction D1 are disposed in the display area of the display panel. In an exemplary embodiment, the pixels P may be defined by an area, in which the gate and data lines 110 and 120 cross each other and a pixel electrode is disposed. Each of the pixels P includes a switching element 130 connected to the gate and data lines 110 and 120, a liquid crystal capacitor CLC connected to the switching element 130, and a storage capacitor CST connected to the liquid crystal capacitor CLC.

The timing controller 400 provides the data and gate driving circuits 200 and 300 with data signals, e.g., a red data signal R, a green data signal G and a blue data signal B, and timing signals, and the timing controller 400 controls a display of the display panel 100. In one exemplary embodiment, for example, the timing controller 400 receives the data signals R, G and B including red, green and blue signals received from an external apparatus, a vertically synchronized signal Vsync, a horizontally synchronized signal Hsync, a main clock signal MCLK and a data enable signal DE. The timing controller 400 provides the gate driving circuit 300 with a gate control signal GCS. The gate control signal GCS includes a gate select signal CPV which controls an output of gate on/off signals, a vertically synchronized start signal STV which selects a gate line 110, and an output enable signal OE. In an exemplary embodiment, the timing controller 400 provides the data driving circuit 200 with a data control signal DCS. The data control signal DCS includes the data signals R, G and B, a clock signal CLKA, a load signal CLKB, a data latch signal CLK1 and a start pulse DIO as shown in FIG. 4 which will be described in greater detail later. In an exemplary embodiment, the timing controller 400 of the display apparatus 1000 as shown in FIG. 1 may transfer the data signals R, G and B to the data driving circuit 200 using a mini low-voltage differential signaling (“mLVDS”) interface method.

The timing controller 400 may generate the data signals R, G and B including an output buffer control signal ACS outputted from the output buffer controller 600. Hereinafter, the output buffer control signal ACS will be described in detail.

The timing controller 400 outputs the data signal received from the external apparatus to the data compensator 500. In one exemplary embodiment, for example, the data compensator 500 includes a memory that stores a compensated data signal F(n−1)′ of an (N−1)-th frame. The data compensator 500 may includes a look-up table (not shown) mapping a compensator image signal or an operation parameter corresponding to a data signal Fn of an N-th frame outputted from the timing controller 400 and the compensated data signal F(n−1)′ of the (N−1)-th frame. The data compensator 500 generates a compensated data signal Fn′ of the N-th frame using the look-up table and outputs the compensated data signal Fn′ of the N-th frame to the output buffer controller 600 and the timing controller 400.

The grayscale voltage generator 700 generates grayscale voltages GMA having positive and negative polarities and corresponding to a luminance of the display panel 100. The grayscale voltages GMA are outputted to the data driving circuit 200.

An end of the gate line 110 is connected to the gate driving circuit 300. The gate driving circuit 300 may include a plurality of gate driving integrated circuits (“IC”s) (not shown). The gate driving circuit 300 receives the gate control signal GCS from the timing controller 400 to sequentially apply a plurality of gate on/off signals to the gate line 110 arranged on the display panel 100.

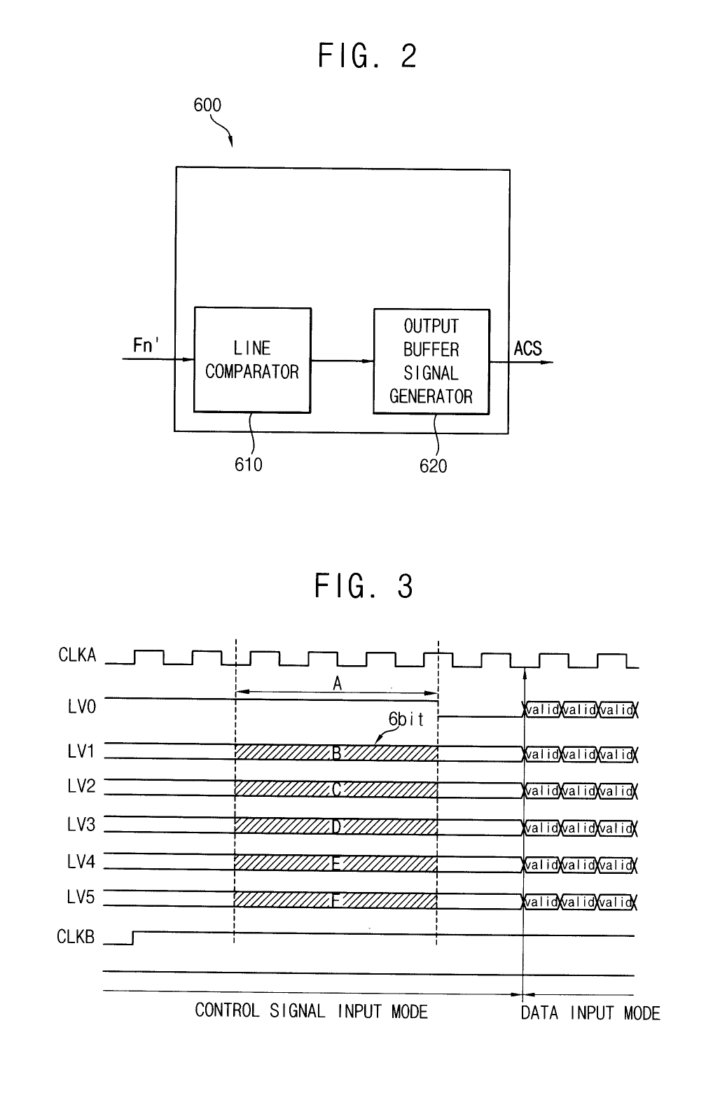

FIG. 2 is a block diagram illustrating an exemplary embodiment of the output buffer controller of FIG. 1.

Referring to FIG. 2, the output buffer controller 600 includes a line comparator 610 and an output buffer signal generator 620.

The line comparator 610 compares the data signals R, G and B applied to each of the data lines 120 using the compensated data signal Fn′ of the N-th frame outputted from the data compensator 500. In one exemplary embodiment, for example, the line comparator 610 compares the data signals R, G and B applied to adjacent data lines 120 and determines whether the data signals R, G and B applied to the adjacent data lines 120 are substantially identical to each other. Then, the line comparator 610 outputs a compared result to the output buffer signal generator 620.

The output buffer signal generator 620 generates the output buffer control signal ACS which controls an output buffer 260 of the data driving circuit 200 based on the compared result outputted from the line comparator 610. The output buffer control signal ACS connects the adjacent data lines 120 with one amplifier when the data signals applied to the adjacent data lines 120 are substantially identical to each other. The output buffer control signal ACS connects the adjacent data lines 120 with corresponding amplifiers that output the corresponding data signals R, G and B when the data signals applied to the adjacent data lines 120 are different from each other. The output buffer signal generator 620 as shown in FIG. 2 outputs the output buffer control signal ACS to the timing controller 400. The timing controller 400 may receive the output buffer control signal ACS, and may embed the output buffer control signal ACS in the data signals R, G and B to be outputted to the data driving circuit 200. Hereinafter, the output buffer control signal ACS will be described in detail.

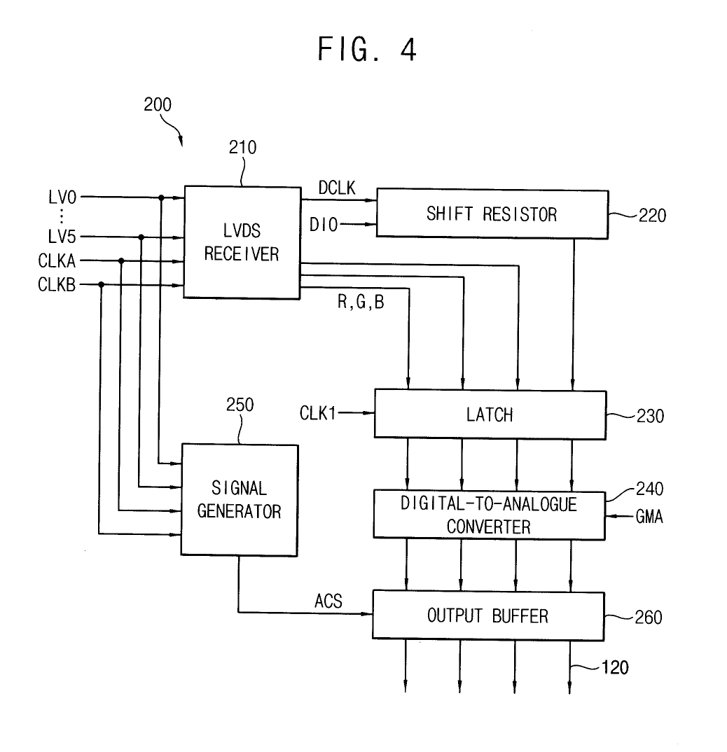

FIG. 3 is a signal timing diagram of data signals inputted to an exemplary embodiment of a data driving circuit of FIG. 1.

Referring to FIG. 3, the data driving circuit 200 is driven by the mLVDS interface method. In an LVDS interface method, voltage swing amplitude of a signal may decrease. A decrease of the voltage swing amplitude of the signal used in the mLVDS interface method is greater than a decrease of the voltage swing amplitude of a signal used in a low-voltage differential signaling (“LVDS”) interface method, such that total current consumption of the driving IC is more decreased. In the mLVDS interface method, the data signals R, G and B are transferred as LV0 to LV5 signals.

In the mLVDS interface method, LV0 signal includes an interval A in which the LV0 signal is maintained at a high level during at least three clocks when the load signal CLKB has a high level. A first low signal of the LV0 signal, which is triggered after the high level of the LV0 signal during at least three clocks, is regarded as a reset signal. Then, the data signals R, G and B are inputted to the data driving circuit through the LV0 to LV5 signals at a rising edge of the clock signal CLKA.

The LV1 to LV5 signals have intervals B, C, D, E and F, respectively, corresponding to the interval A of the LV0 signal. The LV1 to LV5 signals are maintained at a high level during at least three clocks in the intervals B, C, D, E and F, respectively. Thus, the output buffer control signal ACS is outputted to the data driving circuit 200 using the intervals B, C, D, E and F.

In one exemplary embodiment, for example, the output buffer controller 600 outputs the output buffer control signal ACS to the timing controller 400. The timing controller 400 may embed the output buffer control signal ACS in the intervals B, C, D, E and F. Then, the timing controller 400 outputs the data control signal DCS and the LV0 to LV5 signals to the data driving circuit 200. The data control signal DCS includes the clock signal CLKA, the load signal CLKB, the data latch signal CLK1 and the start pulse signal DIO. The LV0 to LV5 signals includes the output buffer control signal ACS.

6-bits signals may be embedded in the intervals B, C, D, E and F of the LV1 to LV5 signals corresponding to the interval A of the LV0, such that the output buffer 260 may be driven in various modes and may be controlled according to the various modes.

FIG. 4 is a block diagram illustrating an exemplary embodiment of the data driving circuit of FIG. 1.

Referring to FIG. 4, the data driving circuit 200 includes an LVDS receiver 210, a shift resistor 220, a latch 230, a digital-to-analogue converter 240, a signal generator 250 and an output buffer 260.

An end of the data lines 120 of the display panel 100 is connected to the data driving circuit 200. The data driving circuit 200 may include a plurality of data driving ICs (not shown). The data driving circuit 200 receives the data control signal DCS, and the LV0 to LV5 signals including the data signals R, G and B and the output buffer control signal ACS from the timing controller 400, and applies the data control signal DCS and the LV0 to LV5 signals to the data lines 120.

The LVDS receiver 210 receives the LV0 to LV5 signals including the data signals R, G and B and the output buffer control signal ACS, the clock signal CLKA and the load signal CLKB. The LVDS receiver 210 generates the data signals R, G and B from the LV0 to LV5 signals, and transfers the data signals R, G and B to the latch 230. In an exemplary embodiment, the LVDS receiver 210 generates a data clock signal DCLK, and transfers the data clock signal DCLK to the shift resistor 220.

The shift resistor 220 receives the data clock signal DCLK and the start pulse DIO which starts an operation. The shift resistor 220 sequentially moves a pulse by the certain numbers of clocks.

The latch 230 stores the data signals R, G and B inputted based on the data latch signal CLK1 and a shifting order of the shift resistor 220. After storing the inputted data signals R, G and B of one horizontal line, the latch 230 transfers the inputted data signals R, G and B of one horizontal line to the digital-to-analogue converter 240.

The digital-to-analogue converter 240 receives the grayscale voltages GMA generated from the grayscale voltage generator 700. In an exemplary embodiment, the digital-to-analogue converter 240 may convert the inputted data signals R, G and B received from the latch 230 to a grayscale data signal based on the grayscale voltages GMA, and output the grayscale data signal to the output buffer 260.

The signal generator 250 receives the LV0 to LV5 signals including the data signals R, G and B and the output buffer control signal ACS, the clock signal CLKA and the load signal CLKB. The signal generator 250 restores the output buffer control signal ACS from the LV0 to LV5 signals, and outputs the output buffer control signal ACS to the output buffer 260.

In an exemplary embodiment, the data driving circuit 200 is explained using the mLVDS interface method as shown in FIG. 2, but not being limited thereto. In an alternative exemplary embodiment, the data signal and the output buffer control signal may be transferred using other methods.

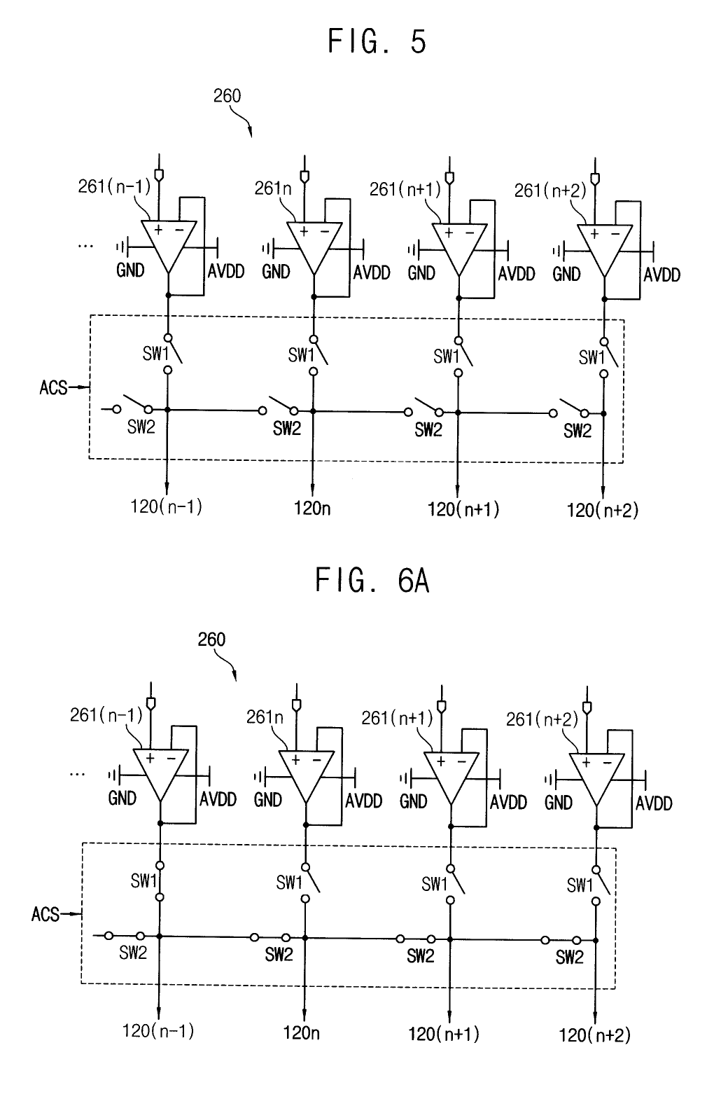

FIG. 5 is a schematic circuit diagram of an exemplary embodiment of the output buffer of FIG. 4.

Referring to FIG. 5, the output buffer 260 includes a plurality of amplifiers 261 respectively connected to the data lines 120, a plurality of first switching elements SW1 respectively disposed between output terminals of the amplifiers 261 and input terminals of the data lines 120, and a plurality of second switching elements SW2 disposed between input terminals of the adjacent data lines 120(n−1), 120n and 120(n−1).

The output buffer 260 amplifies analogue data signals received from the digital-to-analogue converter 240, and applies the amplifier analogue data signals to the data lines 120 of the display panel 100 at the same time.

The first and second switching elements SW1 and SW2 are controlled by the output buffer control signal ACS. In one exemplary embodiment, for example, when adjacent data lines 120(n−1), 120n, 120(n+1) and 120(n+2) receive different data signals, the first switching elements SW1 of the adjacent data lines 120 are maintained in an on-state, and the second switching elements SW2 of the adjacent data lines 120 are maintained in an off-state. Thus, each of the adjacent data lines 120(n−1), 120n, 120(n+1) and 120(n+2) are connected to corresponding amplifiers 261(n−1), 261n, 261(n+1) and 261 (n+2) of the amplifiers 261 that apply the data signal corresponding to the data lines 120.

In an exemplary embodiment, when the adjacent data lines 120(n−1), 120n, 120(n+1) and 120(n+2) receive substantially identical data signals, one first switching element of the first switching elements SW1 connected to the adjacent data lines 120(n−1), 120n, 120(n+1) and 120(n+2) is maintained in the on-state, and other first switching elements of the first switching elements SW1 connected to the adjacent data lines 120(n−1), 120n, 120(n+1) and 120(n+2) are maintained in the off-state. At the same time, the second switching element SW2 connected to the adjacent data lines 120(n−1), 120n, 120(n+1) and 120(n+2) maintains the on-state. Accordingly, the data lines 120 are connected to one amplifier 261, e.g., the amplifier connected to the turned-on first switching element SW1 among the amplifiers connected to the adjacent data lines 120(n−1), 120n, 120(n+1) and 120(n+2). Thus, the number of the driven amplifiers 261 is substantially reduced, and total power consumption of the data driving circuit 200 is thereby substantially reduced.

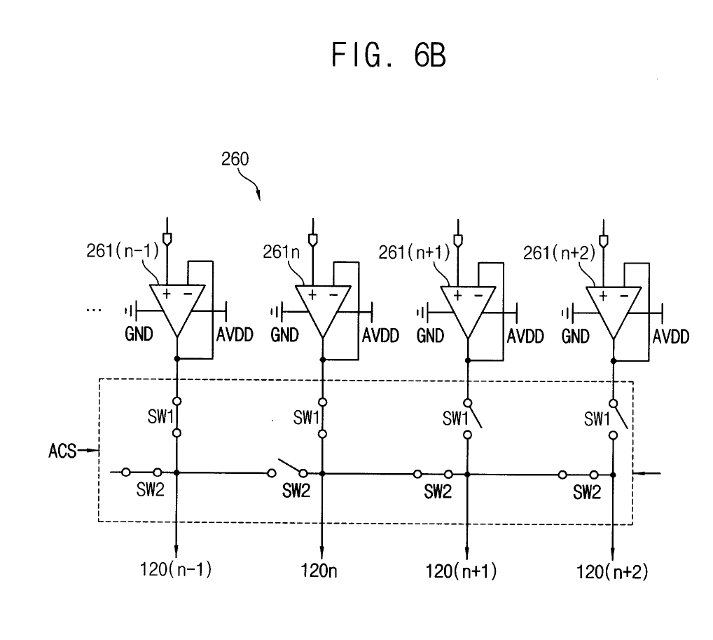

FIG. 6A is a schematic circuit diagram illustrating a connection of the output buffer of FIG. 5 when data lines output data signals substantially identical to each other.

Referring to FIG. 6A, only one amplifier, e.g., the (n−1)-th amplifier 261(n−1) of the amplifiers 261 included in the output buffer 260 is connected to the data lines 120.

When the display panel 100 entirely displays a white image as shown in FIG. 6A, the amplifiers 261 included in the output buffer 260 output voltages substantially identical to each other, and each of the adjacent data lines 120(n−1), 120n, 120(n+1) and 120(n+2) receives the data signals substantially identical to each other.

When each of the adjacent data lines 120(n−1), 120n, 120(n+1) and 120(n+2) receives the data signals substantially identical to each other, only one of the amplifiers 261 included in the output buffer 260 may be driven, and the other amplifiers may not be driven, such that power consumption thereof is substantially reduced.

Therefore, the first switching element SW1 disposed between the (n−1)-th amplifier 261(n−1) and the input terminal of the (n−1)-th data line 120(n−1) is maintained in the on-state, and the first switching elements SW1 respectively disposed between the n-th to (n+2)-th amplifiers 261n, 261(n+1) and 261(n+2) and the n-th to (n+2)-th data lines 120n, 120(n+1) and 120(n+2) are maintained in the off-state. At the same time, the second switching elements SW2 disposed between the input terminals of the adjacent data lines 120(n−1), 120n, 120(n+1) and 120(n+2) are maintained in the on-state.

The n-th to (n+2)-th amplifiers 261n, 261(n+1) and 261(n+2) are not connected to the data lines 120, such that power consumption is substantially reduced by an amount of the power consumed by the n-th to (n+2)-th amplifiers 261n, 261(n+1) and 261(n+2).

FIG. 6B is a schematic circuit diagram illustrating a connection of the output buffer of FIG. 5 when the data lines output data signals different from each other.

Referring to FIG. 6B, the n-th to (n+2)-th data lines 120n, 120(n+1) and 120(n+2) receive the data signals substantially identical to each other, and the (n−1)-th data line 120(n−1) receives the data signal different from the n-th to (n+2)-th data lines 120n, 120(n+1) and 120(n+2).

In one exemplary embodiment, for example, the first switching element SW1 disposed between the (n−1)-th amplifier 261(n−1) and the input terminal of the (n−1)-th data line 120(n−1) is maintained in the on-state, and the second switching element SW2 disposed between the (n−1)-th and n-th data lines 120(n−1) and 120n is maintained in the off-state. Thus, the (n−1)-th data line 120(n−1) receives the corresponding data signal.

At the same time, the first switching element SW1 disposed between the n-th amplifier 261n and the input terminal of the n-th data line 120(n) is maintained in the on-state. In addition, the first switching elements SW1 disposed between the (n+1)-th amplifier 261(n+1) and the (n+1)-th data line 120(n+1) and between the (n+2)-th amplifier 261(n+2) and the (n+2)-th data line 120(n+2) are maintained in the off-state. At the same time, the second switching elements SW2 disposed between the input terminals of the n-th to (n+2)-th data lines 120n, 120(n+1) and 120(n+2) are maintained in the on-state.

The n-th to (n+2)-th data lines 120n, 120(n+1) and 120(n+2), which output the data signals substantially identical to each other, receive the data signals from the n-th amplifier 261n. The (n+1)-th to (n+2)-th amplifiers 261(n+1) and 261(n+2) are not connected to the data lines 120, such that power consumption is substantially reduced by an amount of the power to be consumed by the (n+1)-th to (n+2)-th amplifiers 261(n+1) and 261(n+2).

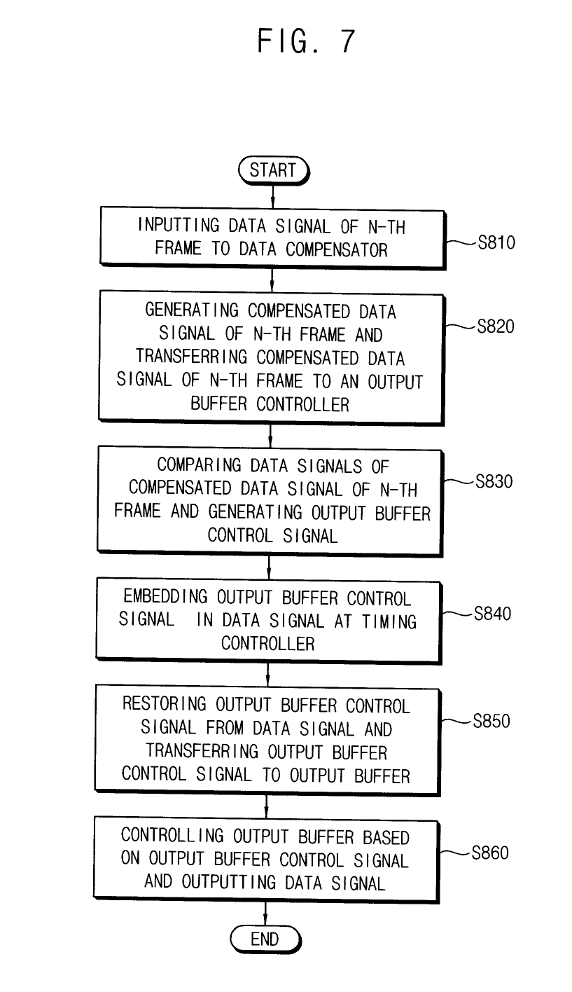

FIG. 7 is a flow chart illustrating an exemplary embodiment of a method for driving the display apparatus of FIG. 1.

Referring to FIGS. 1 and 7, the timing controller 400 of the display apparatus 1000 receives each of the red, green and blue data signals R, G and B of the N-th frame from an external device (not shown), and transfers the data signals R, G and B to the data compensator 500 (step S810).

The data compensator 500 compares the compensated data signal F(n−1)′ of the (N−1)-th frame with the data signal Fn of the N-th frame transferred from the timing controller 400, and generates the compensated data signal Fn′ of the N-th frame. The data compensator 500 transfers the compensated data signal Fn′ of the N-th frame to the output buffer controller 600 (step S820).

The output buffer controller 600 compares the data signals outputted to a first data line and a second data line of the compensated data signal Fn′ of the N-th frame, and generates the output buffer control signal ACS (step S830).

The first and second data lines may be the data lines 120 adjacent to each other.

The output buffer controller 600 outputs the output buffer control signal ACS to the timing controller 400. The timing controller 400 embeds the output buffer control signal ACS in the data signal to generate the data signal (step S840). In an exemplary embodiment, the data signal may be transferred by the mLVDS interface method, but not being limited thereto. In an alternative exemplary embodiment, the other method may be used.

The signal generator 250 restores the output buffer control signal ACS from the data signal transferred from the timing controller 400, and transfers the output buffer control signal ACS to the output buffer 260 (step S850).

The output buffer 260 is controlled by the output buffer control signal ACS, and outputs the data signal to the data lines 120 (step S860).

According to the exemplary embodiments of the method for driving the display apparatus, the adjacent data lines are connected with one amplifier to output the data signal when the adjacent data lines outputs data signals substantially identical to each other. Thus, the amplifiers not connected to the adjacent data lines are not driven, and power consumption of the data driving circuit is thereby substantially reduced.

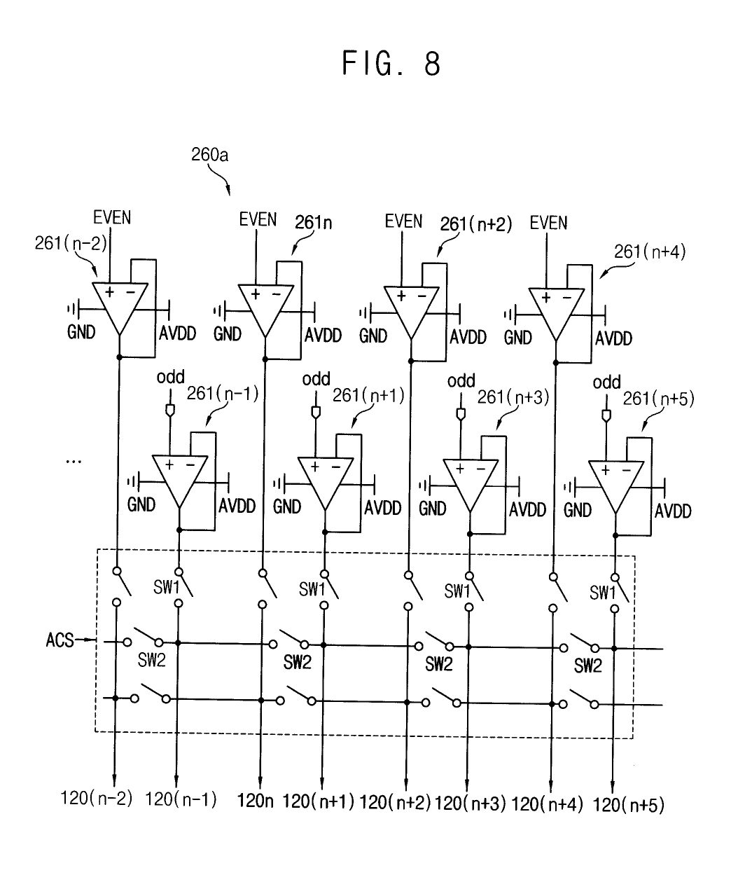

FIG. 8 is a schematic circuit diagram of an alternative exemplary embodiment of the output buffer according to the present invention.

The output buffer in FIG. 8 is substantially the same as the output buffer 260 shown in FIG. 5 except for a circuit connection. The same or like elements shown in FIG. 8 have been labeled with the same reference as used above to describe the exemplary embodiments of the output buffer shown in FIG. 5, and any repetitive detailed description thereof will hereinafter be omitted or simplified.

Referring to FIG. 8, the output buffer 260a includes a plurality of amplifiers 261 respectively connected to the data lines 120, a plurality of first switching elements SW1 respectively disposed between output terminals of the amplifiers 261 and input terminals of the data lines 120, and a plurality of second switching elements SW2 disposed between input terminals of the data lines 120.

The second switching elements SW2 in FIG. 8 connect the input terminals of the even-numbered data lines 120(n−2), 120n, 120(n+2) and 120(n+4) with each other. In addition, the second switching elements SW2 connect the input terminals of the odd-numbered data lines 120(n−1), 120(n+1), 120(n+3) and 120(n+5) with each other.

The first and second switching elements SW1 and SW2 of the output buffer 260 are controlled by the output buffer control signal ACS. In one exemplary embodiment, for example, when the even-numbered data lines 120(n−2) and 120n adjacent to each other receive the data signals different from each other, the first switching elements SW1 connected to the even-numbered amplifiers 261(n−2) and 261n are maintained in the on-state, and the second switching elements SW2 disposed between the input terminals of the even-numbered data lines 120(n−2) and 120n are maintained in the off-state. Accordingly, the even-numbered data lines 120(n−2) and 120n are respectively connected to the even-numbered amplifiers 261(n−2) and 261n that apply the data signal corresponding to the even-numbered data lines 120(n−2) and 120n.

However, when the even-numbered data lines 120(n−2) and 120n adjacent to each other receive the data signals substantially identical to each other, one of the first switching elements SW1 is maintained in the on-state, and the others of the first switching elements SW1 are maintained in the off-state. At the same time, the second switching elements SW2 are maintained in the on-state. Accordingly, the even-numbered data lines 120(n−2) and 120n adjacent to each other are connected to one amplifier, e.g., the (n−2)-th amplifier 261(n−2), and thus the number of the amplifiers 261 to be driven is substantially decreased, and total power consumption of the data driving circuit 200 is thereby substantially reduced.

A method outputting the data signals to the odd-numbered data lines 120(n−1) and 120(n+1) adjacent to each other is substantially the same as the method outputting the data signals to the even-numbered data lines 120(n−2) and 120n adjacent to each other.

A method for driving the display apparatus including the exemplary embodiment of the output buffer in FIG. 8 is substantially the same as the method for driving the display apparatus in FIG. 1.

A method for driving a data driving circuit including the output buffer of FIG. 8 connects the even-numbered or odd-numbered data lines adjacent to each other with one amplifier to output the data signal when the even-numbered or odd-numbered data lines adjacent to each other output the data signals substantially identical to each other. Thus, the amplifiers not connected to the data lines are not driven, and power consumption of the data driving circuit is thereby substantially reduced.

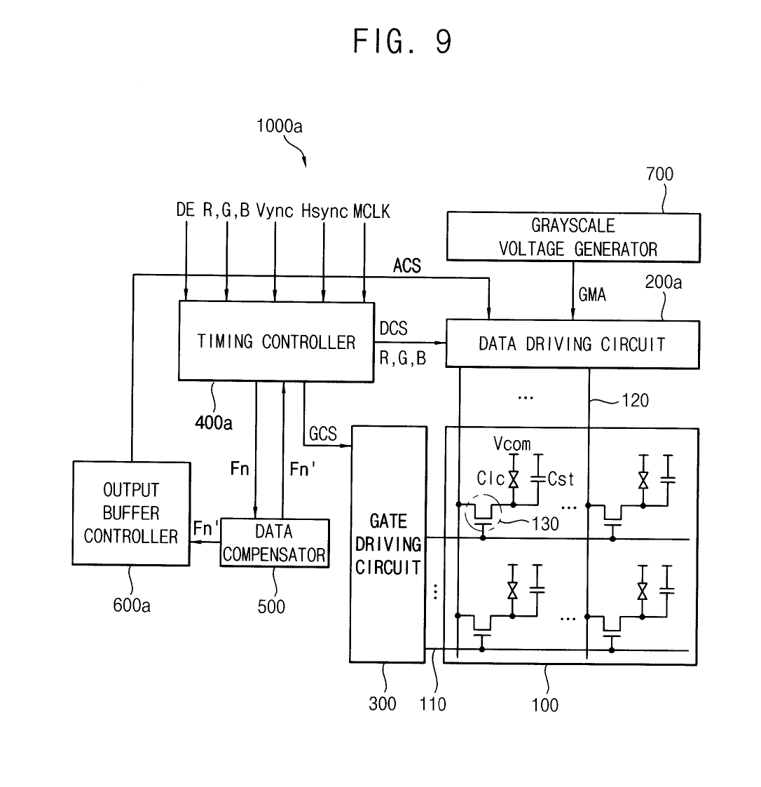

FIG. 9 is a block diagram illustrating an alternative exemplary embodiment of the display apparatus according to the present invention.

The display apparatus in FIG. 9 is substantially the same as the display apparatus shown in FIG. 1 except for a timing controller, a data driving circuit and an output buffer. The same or like elements shown in FIG. 9 have been labeled with the same reference characters as used above to describe the exemplary embodiments of the display apparatus shown in FIG. 1, and any repetitive detailed description thereof will hereinafter be omitted or simplified.

Referring to FIG. 9, an alternative exemplary embodiment of the display apparatus includes a display panel 100, a data driving circuit 200a, a gate driving circuit 300, a timing controller 400a and a data compensator 500, an output buffer controller 600a and a grayscale voltage generator 700.

The timing controller 400a provides the data and gate driving circuits 200a and 300 with the data signals R, G and B and timing signals that control a display of the display panel 100. The data signals R, G and B may be transferred to the data driving circuit 200a using the mLVDS interface method.

The data signals R, G and B of FIG. 9 do not include the output buffer control signal ACS. Thus, the timing controller 400a does not embed the output buffer control signal ACS in the data signals R, G and B.

The output buffer controller 600a may include a line comparator 610 and an output buffer signal generator 620.

The line comparator 610 compares the data signals R, G and B applied to each of the data lines 120 using the compensated data signal Fn′ of the N th frame outputted from the data compensator 500. The line comparator 610 outputs the compared result to the output buffer signal generator 620.

The output buffer signal generator 620 generates the output buffer control signal ACS that controls an output buffer 260 of the data driving circuit 200a based on the compared result received from the line comparator 610. According to the exemplary embodiment in FIG. 9, the output buffer signal generator 620 directly outputs the output buffer control signal ACS to the output buffer 260 of the data driving circuit 200a.

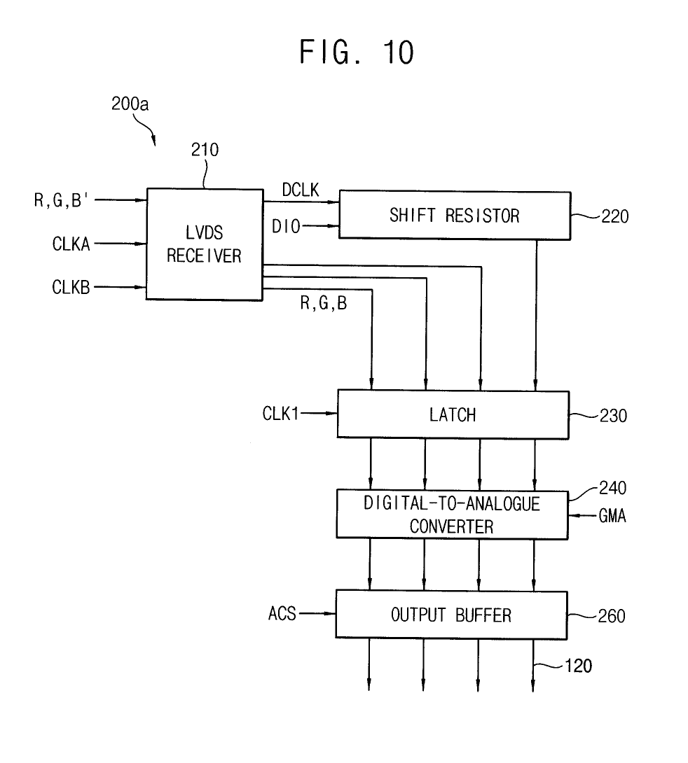

FIG. 10 is a block diagram illustrating an exemplary embodiment of the data driving circuit of FIG. 9.

Referring to FIGS. 9 and 10, the data driving circuit 200a includes an LVDS receiver 210, a shift resistor 220, a latch 230, a digital-to-analogue converter 240 and the output buffer 260.

The data driving circuit 200a of FIG. 10 includes the output buffer 260 which directly receives the output buffer control signal ACS.

The output buffer 260 in FIG. 10 may be substantially the same as the output buffer show in FIGS. 5 and 7.

A method for driving the exemplary embodiment of the display apparatus in FIG. 9 includes connecting the even-numbered and odd-numbered data lines adjacent to each other or the data lines adjacent to each other with one amplifier to output the data signal when the even-numbered and odd-numbered data lines adjacent to each other or the data lines adjacent to each other output the data signal substantially identical to each other. Thus, the amplifiers not connected to the data lines are not driven, and power consumption of the data driving circuit is thereby substantially reduced.

In addition, the output buffer control signal is applied to the data driving circuit, such that the data driving circuit may not include an additional signal generator.

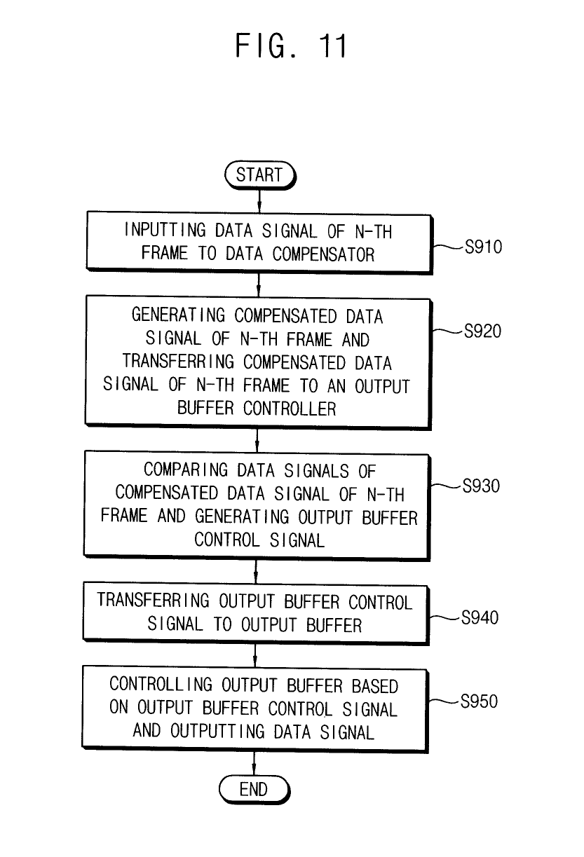

FIG. 11 is a flow chart illustrating an exemplary embodiment of a method for driving the display apparatus of FIG. 9.

Referring to FIGS. 9 and 11, the timing controller 400a of the display apparatus 1000a receives each of the red, green and blue data signals R, G, and B of the N-th frame from the external device (not shown), and transfers the data signals R, G and B to the data compensator 500 (step S910).

The data compensator 500 compares a preset compensated data signal F(n−1)′ of the (N−1)-th frame with the data signal Fn of the N-th frame transferred from the timing controller 400a, and generates a compensated data signal Fn′ of the N-th frame. The data compensator 500 transfers the compensated data signal Fn′ of the N-th frame to the output buffer controller 600a (step S920).

The output buffer controller 600a compares the data signals outputted to a first and second data lines 120 of the compensated data signal Fn′ of the N-th frame, and generates the output buffer control signal ACS (step S930). In an exemplary embodiment, the first and second data lines 120 may be data lines adjacent to each other, e.g., the n-th data line 120n and the (n+1)-th data line 120(n+1). In an alternative exemplary embodiment, the first and second data lines 120 may be even-numbered data lines adjacent to each other, e.g., the (n−2)-th data line 120(n−2) and the n-th data line 120n or odd-numbered data lines, e.g., the (n−1)-th data line 120(n−1) and the (n+1)-th data line 120(n+1) adjacent to each other, as shown in FIG. 8.

The output buffer controller 600a outputs the output buffer control signal ACS to the output buffer 260 of the data driving circuit 200a (step S940).

The output buffer 260 is controlled by the output buffer control signal ACS, and outputs the data signal to the data lines 120 (step S950).

A method for driving the display apparatus in FIG. 11 includes connecting the even-numbered and odd-numbered data lines adjacent to each other or the data lines adjacent to each other with one amplifier to output the data signal when the even-numbered and odd-numbered data lines adjacent to each other or the data lines adjacent to each other output the data signal substantially identical to each other. Thus, the amplifiers not connected to the data lines are not driven, and power consumption of the data driving circuit is thereby substantially reduced.

In addition, the output buffer control signal is applied to the data driving circuit, such that the data driving circuit may not include an additional signal generator.

According to the exemplary embodiments as described herein, the display apparatus and the method for driving the display apparatus connects the even-numbered and odd-numbered data lines adjacent to each other or the data lines adjacent to each other with one amplifier to output the data signal when the even-numbered and odd-numbered data lines adjacent to each other or the data lines adjacent to each other output the data signal substantially same with each other. Thus, the amplifiers not connected to the data lines are not driven, and power consumption of the data driving circuit is thereby substantially reduced.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A data processing method for a display apparatus, the method comprising:
comparing data signals outputted to a first data line and a second data line of a plurality of data lines of a data driving circuit in the display apparatus to generate an output buffer control signal; and
outputting output signals from at least one amplifier of a plurality of amplifiers of an output buffer in the data driving circuit to the first data line and the second data line, wherein the at least one amplifier is selected based on the output buffer control signal.

2. The method of claim 1, wherein the outputting the output signals from the at least one amplifier to the first data line and the second data line comprises:
connecting the first data line and the second data line to a same amplifier of the plurality of amplifiers, when the data signals outputted to the first data line and the second data line are substantially identical to each other; and
respectively connecting the first data line and the second data line to different amplifiers of the plurality of amplifiers, when the data signals outputted to the first data line and the second data line are different from each other.

3. The method of claim 1, wherein the outputting the output signals from the at least one amplifier to the first data line and the second data line comprises:
controlling turning-on and turning-off of a first switching element and a second switching element of the output buffer,
wherein the plurality of amplifiers of the output buffer comprises a first amplifier corresponding to the first data line and a second amplifier corresponding to the second data line,
wherein the first switching element respectively connects an input terminal of the first data line with an output terminal of the first amplifier and an input terminal of the second data line with an output terminal of the second amplifier, and
wherein the second switching element connects the input terminal of the first data line and the input terminal of the second data line with each other.

4. The method of claim 3, wherein the outputting the output signals from the at least one amplifier to the first data line and the second data line comprises:
turning on the first switching element connected between the first amplifier and the first data line, turning off the first switching element connected between the second amplifier and the second data line, and turning-on the second switching element connected between the first data line and the second data line, when the data signals outputted to the first data line and the second data line are substantially identical to each other; and
turning on the first switching element connected between the first amplifier and the first data line, turning on the first switching element connected between the second amplifier and the second data line, and turning off the second switching element, when the data signals outputted to the first data line and the second data line are different from each other.

5. The method of claim 4, wherein the first data line is a k-th data line of the plurality of data lines, the second data line is a (k+1)-th data line of the plurality of data lines, and the second switching element connects an input terminal of the k-th data line and an input-terminal of the (k+1)-th data line with each other, and
wherein k is a natural number.

6. The method of claim 4, wherein the first data line is a k-th data line of the plurality of data lines, the second data line is a (k+2)-th data line of the plurality of data lines, and the second switching element connects an input terminals of the k-th data line and an input terminal of the (k+2)-th data line with each other, and
wherein k is a natural number.

7. The method of claim 1, wherein the comparing the data signals outputted to the first data line and the second data line comprises:
generating a compensated data signal of an N-th frame using a preset data signal of an (N−1)-th frame and a data signal of the N-th frame received from an external device.

8. A data driving circuit comprising:
a data signal receiver;
a digital-to-analogue converter which converts a signal received from the data signal receiver to an analogue data signal; and
an output buffer comprising:
a plurality of amplifiers connected to a plurality of data lines, wherein the plurality of amplifiers includes a first amplifier corresponding to a first data line of the plurality of data lines and a second amplifier corresponding to a second data line of the plurality of data lines;
a first switching element which respectively connects an input terminal of the first data line with an output terminal of the first amplifier and an input terminal of the second data line with an output terminal of the second amplifier; and
a second switching element which connects the input terminal of the first data line and the input terminal of the second data line with each other.

9. The data driving circuit of claim 8, further comprising a signal generator connected to the output buffer, wherein the signal generator generates an output buffer control signal and outputs the output buffer control signal to the output buffer.

10. The data driving circuit of claim 8, wherein the first data line is a k-th data line of the plurality of data lines, the second data line is a (k+1)-th data line of the plurality of data lines, and the second switching element connects an input terminal of the k-th data line and an input terminal of the (k+1)-th data line with each other, and
wherein k is a natural number.

11. The data driving circuit of claim 8, wherein the first data line is a k-th data line of the plurality of data lines, the second data line is a (k+2)-th data line of the plurality of data liens, and the second switching element connects an input terminal of the k-th data line and an input terminal of the (k+2)-th data line with each other, and
wherein k is a natural number.

12. A display apparatus comprising:
a display panel including a plurality of data lines;
a timing controller which outputs data signals;
an output buffer controller which compares the data signals outputted to a first data line of the plurality of data lines and a second data line of the plurality of data lines to generate an output buffer control signal; and
a data driving circuit including an output buffer,
wherein the output buffer comprising:
a plurality of amplifiers connected to the plurality of data lines of the display panel, wherein the plurality of amplifiers includes a first amplifier corresponding to the first data line and a second amplifier corresponding to the second data line;
a first switching element which respectively connects an input terminal of the first data line with an output terminal of the first amplifier and an input terminal of the second data line with an output terminal of the second amplifier; and
a second switching element which connects the input terminals of the first data line and the input terminal of the second data line with each other.

13. The display apparatus of claim 12, wherein the timing controller outputs the data signals including the output buffer control signal to the data driving circuit.

14. The display apparatus of claim 13, wherein the output buffer controller is connected to the timing controller and outputs the output buffer control signal to the timing controller, and
the timing controller generates the data signals including the output buffer control signal.

15. The display apparatus of claim 14, wherein the data driving circuit further comprises a signal generator connected to the timing controller and the output buffer.

16. The display apparatus of claim 12, wherein the output buffer controller is directly connected to the output buffer, and outputs the output buffer control signal to the output buffer.

17. The display apparatus of claim 12, wherein the first data line is a k-th data line of the plurality of data lines, the second data line is a (k+1)-th data line of the plurality of data lines, and the second switching element connects an input terminal of the k-th data line and an input terminal of the (k+1)-th data line with each other, and
wherein k is a natural number.

18. The display apparatus of claim 12, wherein the first data line is a k-th data line of the plurality of data lines, the second data line is a (k+2)-th data line of the plurality of data lines, and the second switching element connects an input terminals of the k-th data line and an input terminal of the (k+2)-th data line with each other, and
wherein k is a natural number.

19. The display apparatus of claim 12, further comprising a data compensator connected to the output buffer controller and the timing controller, wherein the data compensator generates a compensated data signal of an N-th frame using a preset data signal of an (N−1)-th frame and a data signal of the N-th frame received from an external device.

20. The display apparatus of claim 19, wherein the output buffer controller receives the compensated data signal of the N-th frame from the data compensator.
